(19) United States
(12) Patent Application Publication
(10) Pub. No.: US 2006/0075906 A1
(43) Pub. Date: Apr. 13, 2006

(54) Hot dog frying pan

(76) Inventor: Chung-Ting Tseng, Taipei (TW)

Correspondence Address: Bruce B. Troxell;Troxell Law Office, PLLC, 5205 Leesburg Pike--Suite1404, Falls Church, VA, 22041, US

(21) Appl. No.: 10/827,211

(22) Filed: Apr. 20, 2004

(51) Int. Cl. A47J 37/10

(52) U.S. Cl. 99/422

(57) ABSTRACT

A hot dog frying pan includes a frying pan with a carrying handle, a metal rack mounted in the frying pan for holding hot dogs for frying, the rack having a plurality of cylindrical rollers pivotally arranged in parallel and a plurality of gears meshed with one another and adapted to rotate the cylindrical rollers, and a crank handle coupled to one cylindrical roller for enabling the user to rotate the cylindrical rollers with the hand.

### BACKGROUND OF THE INVENTION

1. Field of the Invention

The present invention relates generally to a cooking utensil and more specifically, to a hot dog frying pan for frying hot dog.

2. Description of the Related Art

Hot dog is a kind of fast food of general favorite. There are cooking apparatus for frying hot dogs. However, because these cooking apparatus are designed for use in hot dog booths, convenience stores, shops, etc., they are expensive and not suitable for home use. When frying hot dogs at home, people may use a frying pan. However, because hot dogs are disposed in contact with the frying pan during frying, they tend to be scorched.

Therefore, it is desirable to provide a hot dog frying pan, which is practical for home use to evenly frying hot dogs.

### SUMMARY OF THE INVENTION

The present invention has been accomplished under the circumstances in view. It is the main object of the present invention to provide a hot dog frying pan, which is practical for home use. It is another object of the present invention to provide a hot dog frying pan, which keeps hot dogs rotated to prevent scorch during frying.

To achieve these and other objects of the present invention, the hot dog frying pan comprises a frying pan for drying, the frying pan having a handle at one side for the holding of the hand, a metal rack mounted in the frying pan for holding hot dogs for frying, the rack comprising a plurality of cylindrical rollers pivotally arranged in parallel, a plurality of first gears respectively fixedly mounted on one end of each of the cylindrical rollers, and a plurality of second gears respectively meshed between the first gears, one the cylindrical roller having a roller shaft extended out of the rack; and drive means coupled to the roller shaft and adapted to rotate the respective cylindrical roller and to further drive the second gears to rotate the first gears and the others of the cylindrical rollers. The drive means can be a crank handle, or a DC motor.

### BRIEF DESCRIPTION OF THE DRAWINGS

FIG. 1 is a perspective view of a hot dog frying pan according to the first embodiment of the present invention.

FIG. 2 is an exploded view of the hot dog frying pan according to the first embodiment of the present invention.

FIG. 3 is a perspective view of a hot dog frying pan according to the second embodiment of the present invention.

FIG. 4 is an exploded view of the hot dog frying pan according to the present invention.

### DETAILED DESCRIPTION OF THE INVENTION

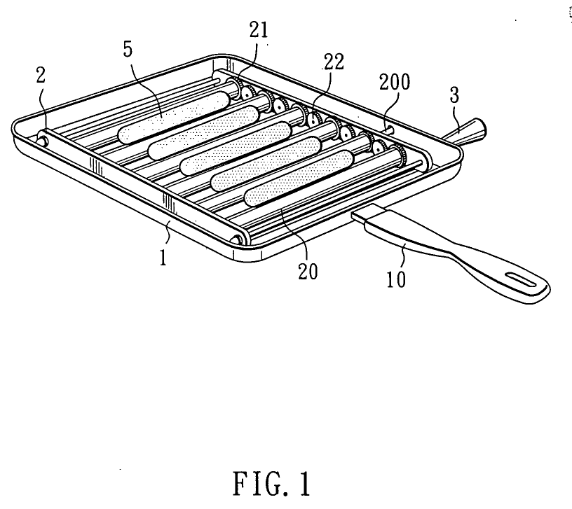

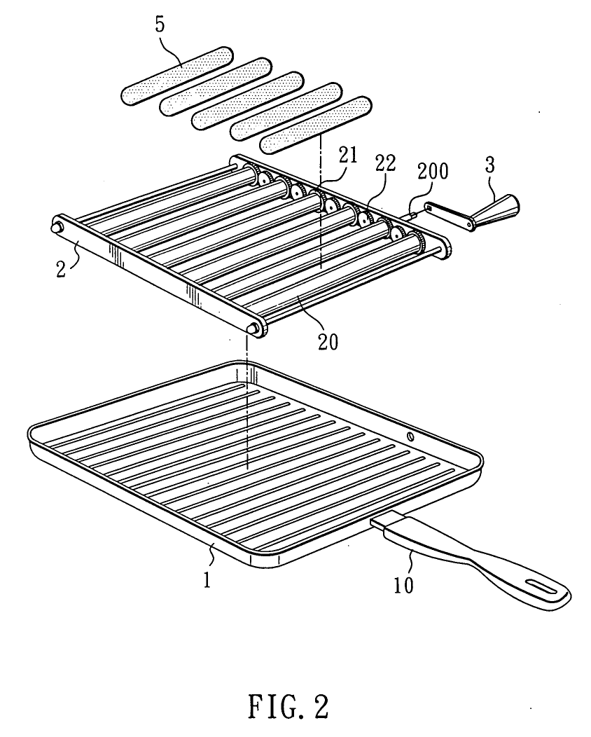

Referring to FIGS. 1 and 2, a hot dog frying pan in accordance with the first embodiment of the present invention is shown comprised of a frying pan 1, a metal rack 2, and a crank handle 3. The frying pan 1 is a metal pan used for drying, having a handle 10 at one side for the holding of the hand. The rack 2 is mounted in the frying pan 1 for holding hotdogs 5 for frying, comprising a plurality of cylindrical rollers 20 pivotally arranged in parallel, a plurality of first gears 21 respectively fixedly mounted on one end of each of the cylindrical rollers 20, and a plurality of second gears 22 respectively meshed between the first gears 21 at each two adjacent cylindrical rollers 20. One cylindrical roller 20 comprises a roller shaft 200 extended out of the rack 2. The crank handle 3 is fastened to the roller shaft 200 for turning by hand to rotate the respective cylindrical roller 20 and to further drive the other cylindrical rollers 20 to rotate via the first gears 21 and the second gears 22.

When in use, the user can hold the handle 10 with the hand to move the hot dog frying pan to the gas burner of the gas range, and then hot dogs 5 are supported between each two adjacent cylindrical rollers 20 of the rack 2 above the frying pan 1. During frying, the user can turn the crank handle 3 to rotate the cylindrical rollers 20, causing cylindrical rollers 20 to turn hot dogs 5 continuously, and therefore hot dogs 5 are evenly and thoroughly fried. Because hot dogs 5 are kept away from the frying pan 1 at a distance, hot dogs 5 will not be scorched.

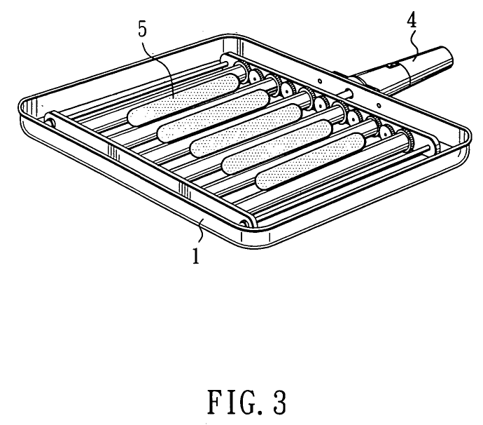

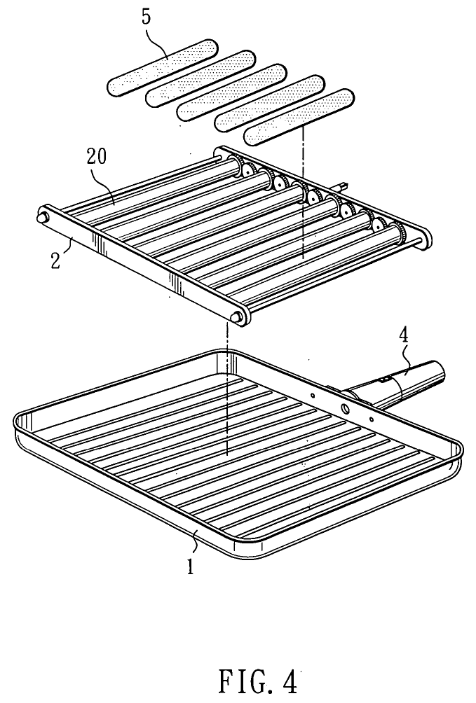

FIGS. 3 and 4 show an alternate form of the hot dog frying pan. This embodiment is substantially similar to the embodiment shown in FIGS. 1 and 2 with the exception of the use of a DC motor 3 instead of the aforesaid crank handle 3. The DC motor 3 is directly coupled to the roller shaft 200 for turning the roller cylinders 20 automatically.

A prototype of hot dog frying pan has been constructed with the features of FIGS. 1˜4. The hot dog frying pan functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

1-3. (canceled)

4. A hot dog frying pan structure comprising:
a) a frying pan having a handle;
b) a metal rack located on a top surface of the frying pan and having:
i) a plurality of rollers, each of the plurality of rollers having a first gear located on a first end thereof, a selected roller of the plurality of rollers having a roller shaft protruding outwardly from the first end thereof;
ii) a plurality of second gears, one second gear of the plurality of second gears is located between each set of two adjacent first gears; and
iii) a turning mechanism directly connected to the roller shaft of the selected roller and controlling a rotation of the plurality of rollers.

5. The hot dog frying pan structure according to claim 4, wherein the turning mechanism is a crank.

6. The hot dog frying pan structure according to claim 4, wherein the turning mechanism is a motor.
